(19) United States
(12) Patent Application Publication
(10) Pub. No.: US 2007/0051928 A1
(43) Pub. Date: Mar. 8, 2007

(54) Dispersions of inherently conductive polymer in non-ionic waterborne polymers

(75) Inventor: Stephen D. Horton, Avon Lake, OH (US)

Correspondence Address: POLYONE CORPORATION, 33587 WALKER ROAD, AVON LAKE, OH, 44012, US

(73) Assignee: PolyOne Corporation, Avon Lake, OH (US)

(21) Appl. No.: 10/595,692

(22) PCT Filed: Nov. 10, 2004
(86) PCT No.: PCT/US04/37371

§ 371 Date: May 5, 2006

Related U.S. Application Data
(60) Provisional application No. 60/520,026, filed on Nov. 14, 2003.

(51) Int. Cl. H01B 1/12

(52) U.S. Cl. 252/500

(57) ABSTRACT

A mixture of inherently conductive polymers and non-ionic waterborne polymers is disclosed. A preferred mixture is lignosulfonic acid-grafted polyaniline and a breathable polyurethane. Coatings of the mixture can be used as anti-fouling marine coatings; anti-static fabrics, coatings and packaging; batteries; conductive inks; conductive adhesives; EMI/RFI shielding articles, radar or microwave absorption articles, and sensors.

### CLAIM OF PRIORITY

This application claims priority from U.S. Provisional Patent Application Ser. No. 60/520,026 bearing Attorney Docket Number 12003025 and filed on Nov. 14, 2003.

### FIELD OF THE INVENTION

This invention relates to dispersions of inherently conductive polymer in waterborne polymers.

### BACKGROUND OF THE INVENTION

Inherently conductive polymers have been found to be very useful in a variety of electrically active materials, such as anti-fouling marine coatings; anti-static fabrics, coatings and packaging; batteries; conductive inks; conductive adhesives; EMI/RFI shielding articles, radar or microwave absorption articles, and sensors.

Inherently conductive polymers can be the matrix of the coating. More preferably because of cost, inherently conductive polymers are dispersed in an inert binder to serve as the matrix or continuous phase of the coating.

### SUMMARY OF THE INVENTION

What the art needs is a dispersion of inherently conductive polymers in a binder that is environmentally friendly, relatively inexpensive, easy to apply, and good performing.

The present invention solves the problem in the art by providing a mixture of inherently conductive polymer in a non-ionic waterborne polymer, preferably a non-ionic waterborne polymer containing acrylic monomer or urethane monomer. More preferably, the non-ionic polymer is an aqueous “breathable” polyurethane binder.

Most particularly, the present invention uses a polyurethane binder that is an aliphatic polyether waterborne urethane polymer that has a high moisture vapor transmission rate (MVTR).

One aspect of the invention is a coatable mixture comprising inherently conductive polymer and a non-ionic waterborne polymer.

A feature of the invention is that the non-ionic polymer does not interfere with the conductive properties of the inherently conductive polymer.

An advantage of the present invention is the coatable mixture is stable under conventional storage and application conditions, is capable of renewing conductive polymeric properties of the inherently conductive polymer because the preferred non-ionic polyurethane has a high MVTR that causes rapid absorption of moisture by the conductive polymer which is important for good conductivity.

Other advantages of the invention will become apparent when considering the embodiments of the invention.

### EMBODIMENTS OF THE INVENTION

Inherently Conductive Polymers

Inherently conductive polymers suitable for the invention include polymers having repeating monomeric units of aniline, thiophene, pyrrole, phenyl mercaptan, and the like. Other examples include a conducting polymer selected from the group consisting of substituted and unsubstituted polyparaphenylenevinylenes, substituted and unsubstituted polyanilines, substituted and unsubstituted polyazines, substituted and unsubstituted polythiophenes, substituted and unsubstituted polyparaphenylenes, substituted and unsubstituted poly-p-phenylene sulfides, substituted and unsubstituted polyfuranes, substituted and unsubstituted polypyrroles, substituted and unsubstituted polyselenophene, substituted and unsubstituted polyacetylenes, mixtures thereof, and copolymers thereof. These conductive polymers are disclosed in a variety of patents, including U.S. Pat. No. 5,069,820 (Jen et al.); U.S. Pat. No. 5,160,457 (Elsenbaumer); U.S. Pat. No. 5,185,100 (Han et al.); U.S. Pat. No. 5,281,363 (Shacklette et al.); U.S. Pat. No. 5,378,403 (Shacklette); U.S. Pat. No. 5,422,423 (Shacklette et al.); U.S. Pat. No. 5,456,862 (Kwan-Yue et al.); U.S. Pat. No. 5,567,355 (Wessling et al.); U.S. Pat. No. 5,700,398 (Angelopoulos et al.) and U.S. Pat. No. 5,911,918 (Shacklette et al.). As described in these patents the inherently conductive polymer is often doped with an acid such as hydrochloric acid or p-toluene sulfonic acid.

Particularly preferred is a substituted polyaniline such as disclosed in U.S. Pat. No. 5,968,417 (Visawanathan) and more particularly that marketed by PolyOne Corporation as Teslart™ inherently conductive polymers. This substituted polyaniline is lignosulfonic acid-grafted polyaniline.

Non-Ionic Waterborne Polymers

Waterborne polymers are useful in the present invention because of the desire in the industry to avoid organic solvents. Non-ionic waterborne polymers provide a stable environment for the operation of the inherently conductive polymer. It has been found that ionic waterborne polymers, either cationic or anionic, adversely affect the conductivity of the inherently conductive polymer.

Commercially available non-ionic waterborne polymers are known to contain polymers with either acrylic monomers or urethane monomers. This type of polymer is emerging in industry as a useful non-ionic carrier for a variety of specialized additives for the coatings industry. As such new non-ionic waterborne polymers become available, one skilled in the art without undue experimentation will be able to determine the suitability of such new products for use in the present invention.

Polyurethane

Non-ionic polyurethanes are preferred for the present invention, especially those which are called “breathable” polyurethanes because they exhibit high MVTR properties.

Breathable polyurethanes comprise (a) poly(alkylene oxide) side-chain units in an amount comprising about 12 wt. % to about 80 wt. % of the polyurethane, wherein (i) alkylene oxide groups in said poly(alkylene oxide) side-chain units have from 2 to 10 carbon atoms and are unsubstituted, substituted, or both unsubstituted and substituted, (ii) at least about 50 wt. % of said alkylene oxide groups are ethylene oxide, and (iii) the amount of side-chain units is (i) at least about 30 wt. % when the molecular weight of side-chain units is less than about 600 grams/mole, (ii) at least about 15 wt. % when the molecular weight of side-chain units is from about 600 to about 1,000 grams/mole, and (iii) at least about 12 wt. % when the molecular weight of side-chain units is more than about 1,000 grams/mole, and (b) poly(ethylene oxide) main-chain units in an amount comprising less than about 25 wt. % of the polyurethane.

Such breathable polyurethanes are disclosed in detail in United States Patent Publication 20030195293 (Lubnin et al.).

Non-limiting commercial examples of polyurethanes suitable for the invention include Permax™ 200 and 220 urethane emulsions available from Noveon, Inc. of Brecksville, Ohio. Additional information can be found at www.noveoncoatings.com.

Mixing of Inherently Conductive Polymers and Waterborne Polymers

Conventional mixing equipment is used to thoroughly mix the inherently conductive polymer into the non-ionic polymer emulsion.

The amount of inherently conductive polymer added to the polymer emulsion can range from about 5 to about 50 weight percent of total solids, and preferably from about 10 to about 25 weight percent of total solids of the mixture.

Optional Ingredients

A variety of ingredients commonly used in the coatings industry can also be included in the mixture of the present invention. Non-limiting examples of such optional additives include slip agents, antiblocking agents, antioxidants, ultraviolet light stabilizers, quenchers, plasticizers, lubricants, antistatic agents, fire retardants, and fillers such as glass fibers, talc, chalk, or clay. Of these fillers, the properties of nanoclay can add stiffness, toughness, and charring properties for flame retardancy. Such optional additives can be included in the mixture of the present invention in an amount from about 0 to about 80, and preferably from about 0.1 to about 50 weight percent. Most preferably, the amount is about 1 to about 30 weight percent of the total solids of the mixture.

Any conventional colorant useful in coatings and paints is also acceptable for use in the present invention. Conventional colorants can be employed, including inorganic pigments such as titanium dioxide, iron oxide, chromium oxide, lead chromate, carbon black, silica, talc, china clay, metallic oxides, silicates, chromates, etc., and organic pigments, such as phthalocyanine blue, phthalocyanine green, carbazole violet, anthrapyrimidine yellow, flavanthrone yellow, isoindoline yellow, indanthrone blue, quinacridone violet, perylene reds, diazo red and others. The amount of colorant can range from none at all to about 30, and preferably from about 1.5 to about 10 weight percent of total solids of the mixture.

An especially desired optional ingredient is a non-ionic thickener or anti-settling agent to promote better retained dispersion of the inherently conductive polymer particles in the non-ionic waterborne polymer after initial mixing and when coating the mixture in larger film thicknesses.

Commercially available thickeners or rheology modifiers are sold by Elementis Specialties of Hightstown, NJ under the Rheolate brand, some of which are believed to be non-ionic associative urethane thickeners. More information can be found at www.elementis-specialties.com. The amount of thickener can range from about none at all to about 5, and preferably from about 1 to about 3 weight percent of total solids of the mixture.

Usefulness of the Invention

All of the advantages and usefulness of a breathable urethane polymer as disclosed in United States Patent Publication 20030195293 (Lubnin et al.) are also present in the mixture of the present invention. But the inherently conductive polymer ingredient adds to those properties by making the mixture electrically active and capable of serving as an electron transfer agent.

Surface resistivities, using the Four Point Probe test (ASTMD-257-99) can range from about 1.00×10³ to about 1.00×10¹² Ohms/square.

The coatable mixture can be prepared with approximately 30% solids and a Brookfield viscosity of about 125 Centapoise. This permits ease of application to a substrate via spray, brush, roll, knife, or other means of application.

Thus, mixtures of the present invention can be very useful in a variety of electrically active materials, such as anti-fouling marine coatings; anti-static fabrics, coatings and packaging; batteries; conductive inks; conductive adhesives; EMI/RFI shielding articles, radar or microwave absorption articles, and sensors.

While not being limited to a particular theory, it is believed that the non-ionic nature of waterborne polymers used in the present invention inhibits coagulation of the mixture that might otherwise be caused by protons present in the mixture due to the acidic nature of the inherently conductive polymer. Moreover, it is believed that the high MVTR of the commercial Permax® polyurethane material promotes rapid re-absorption of water from the environment by the inherently conductive polymer, which is important to good conductivity values for the inherently conductive polymer, after the mixture of the present invention is coated on a surface and dried.

Further embodiments are described in the following examples.

### EXAMPLES

Table 1 shows the commercial ingredients used in Examples 1-5 and Comparison Example A.

TABLE 1
Source of Ingredients

| Ingredient | Pur- | Brand | Generic | | Source |
|---|---|---|---|---|---|
| Name | pose | Name | Name | Source | Location |
| Bayhydrol | Poly- | Bayhydrol | Ionic | Bayer | Pittsburgh, |
| 110 | meric | | Waterborne | | PA |
| | Bind- | | Poly- | | |
| | er | | urethane | | |
| | | | Dispersion | | |
| Permax | Poly- | Permax | Non-Ionic | Noveon | Brecksville, |
| 220 | meric | | Waterborne | | OH |
| | Bind- | | Poly- | | |
| | er | | urethane | | |
| | | | Dispersion | | |
| Teslart ™ | Con- | Teslart ™ | Poly- | PolyOne | Avon Lake, |
| Wet Cake | duc- | | aniline | Corp. | OH |
| | tive | | chains | | |
| | Fill- | | grafted | | |
| | er | | to ligno- | | |
| | | | sulfonic | | |
| | | | acid | | |
| Rheolate | Thick- | Rheolate | Non-Ionic | Elemen- | Hightstown, |
| 300 | ener | | Thickener | tis | NJ |
| | Anti | | | Spe- | |
| | Set- | | | cial- | |
| | tling | | | ties | |
| | Agent | | | | |

Table 2 shows the Recipes, Method of Preparation, and resulting Properties of Examples 1-5 of mixtures of the present invention, in comparison with Comparison Example A, which uses a polyurethane without high MVTR.

TABLE 2
Recipes, Preparation, and Properties

| | | | | | | |
|---|---|---|---|---|---|---|
| Ingredient | Example 1 | 2 | 3 | 4 | 5 | A |

Recipes

| | | | | | | |
|---|---|---|---|---|---|---|
| Bayhydrol 110 | 0% | 0% | 0% | 0% | 0% | 89.0% |
| Permax 220 | 89.0% | 87.2% | 78.8% | 71.8% | 66.0% | 0% |
| Teslart ™ Wet Cake | 11.0% | 10.7% | 19.3% | 26.5% | 32.4% | 11.0% |
| (28.5% Solids) | | | | | | |
| Rheolate 300 | 0% | 2.1% | 1.9% | 1.7% | 1.6% | 0% |

Preparation

| | | | | | | |
|---|---|---|---|---|---|---|
| Mixing Equipment | Marine Prop | Marine Prop | Marine Prop | Marine Prop | Marine Prop | Marine Prop |
| Mixing Temp. | Room | Room | Room | Room | Room | Room |
| Mixing Speed | 200-500 RPM | 200-500 RPM | 200-500 RPM | 200-500 RPM | 200-500 RPM | 200-500 RPM |
| Order of Addition | Permax & Teslart, | Permax & Teslart, | Permax & Teslart, | Permax & Teslart, | Permax & Teslart, | Bayhydrol |
| of Ingredients | mixed well | mixed well, then | mixed well, then | mixed well, then | mixed well, then | & Teslart, |
| | | Rheolate | Rheolate | Rheolate | Rheolate | mixed well |
| Form of Product | Dispersion | Dispersion | Dispersion | Dispersion | Dispersion | Dispersion |
| After Mixing | | | | | | |

Properties

| | | | | | | |
|---|---|---|---|---|---|---|
| Time to Coagulation | >90 | >90 | >90 | >90 | >90 | <1 |
| at Room Temp. (Days) | | | | | | |
| Surface Resistivity | Not Measured- | 9 * 10E10 | 3 * 10E5 | 3 * 10E5 | 2 * 10E5 | Not Measured- |
| (ASTM D257-99) | Too Much | | | | | Dispersion |
| Ohms/sq | Settling | | | | | Coagulated |
| (2 mils thick (0.05 | | | | | | |
| mm) dry, 24 hr @ | | | | | | |
| 50% RH) | | | | | | |

Table 2 shows that all of Examples 1-5 using a non-ionic polyurethane do not coagulate within a day, as compared with use of an ionic polyurethane of Comparison A Example, does coagulate. Examples 3-5 perform better concerning surface resistivity than Example 2, indicating that a thickener or anti-settling agent is preferable in the mixture of the present invention. Also, surface resistivity decreases as loading of inherently conductive polymer increases, as shown by Example 5 having a lower surface resistivity than Example 3.

The invention is not limited to the above embodiments. The claims follow.

What is claimed is:

1. A coatable mixture, comprising:
inherently conductive polymer, and
a non-ionic waterborne polymer.

2. The mixture of claim 1, wherein the inherently conductive polymer is polyaniline.

3. The mixture of claim 2, wherein the inherently conductive polymer is lignosulfonic acid-grafted polyaniline.

4. The mixture of claim 1, wherein the non-ionic waterborne polymer is selected from the group consisting of acrylic polymers and urethane polymers.

5. The mixture of claim 4, wherein the urethane polymer is an aliphatic polyether polyurethane.

6. The mixture of claim 5, wherein the polyurethane has a high MVTR.

7. The mixture of claim 1, further comprising a non-ionic thickener.

8. The mixture of claim 1, further comprising a non-ionic anti-settling agent.

9. A coating comprising a mixture comprising inherently conductive polymer and a non-ionic waterborne polymer.

10. An article protected by a coating comprising a mixture comprising inherently conductive polymer and a non-ionic waterborne polymer.

11. (canceled)

12. The coating of claim 9, wherein the inherently conductive polymer is polyaniline.

13. The coating of claim 9, wherein the non-ionic waterborne polymer is selected from the group consisting of acrylic polymers and urethane polymers.

14. The coating of claim 13, wherein the urethane polymer is an aliphatic polyether polyurethane.

15. The coating of claim 14, wherein the polyurethane has a high MVTR.

16. The coating of claim 9, further comprising a non-ionic thickener.

17. The coating of claim 9, further comprising a non-ionic anti-settling agent.

18. The article of claim 10, wherein the inherently conductive polymer is polyaniline and wherein the non-ionic waterborne polymer is selected from the group consisting of acrylic polymers and urethane polymers.

19. The article of claim 18, further comprising a non-ionic thickener.

20. The article of claim 18, further comprising a non-ionic anti-settling agent.
